(19) United States
(12) Patent Application Publication
(10) Pub. No.: US 2026/0050673 A1
(43) Pub. Date: Feb. 19, 2026

(54) MODIFYING ARTIFICIAL NEURAL NETWORKS FOR TESTING SECURITY

(71) Applicant: INTERNATIONAL BUSINESS MACHINES CORPORATION, Armonk, NY (US)

(72) Inventors: Ora Nova Fandina, Tel Aviv (IL); Orna Raz, Haifa (IL); George Kour, Tel Aviv (IL); Marcel Zalmanovici, Kiriat Motzkin (IL); Eitan Daniel Farchi, Pardes Hana (IL); Ateret Anaby-Tavor, Givat Ada (IL)

(21) Appl. No.: 18/804,535

(22) Filed: Aug. 14, 2024

(51) Int. Cl. G06F 21/57

(52) U.S. Cl. CPC G06F 21/577; G06F 2221/033

(57) ABSTRACT

Systems, methods, and computer program products for modifying an artificial neural network are described herein. A method comprises reading an input artificial neural network; iteratively generating a modified artificial neural network, wherein generating the modified artificial neural network comprises removing at least one node from the artificial neural network; determining a performance score for the modified artificial neural network; and selecting a subset of the nodes of the artificial neural network. Determining the performance score may comprise providing a plurality of input prompts to the modified artificial neural network; generating a plurality of outputs based on the plurality of input prompts, determining output scores for the plurality of outputs, and determining the performance score based on the output scores.

### BACKGROUND

Embodiments of the present disclosure relate to modifying artificial neural networks, and more specifically, to modifying artificial neural networks for testing security of the artificial neural networks.

### SUMMARY

According to embodiments of the present disclosure, methods of and computer program products for modifying an artificial neural network are disclosed. A method for modifying an artificial neural network may include reading an input neural network. A method for modifying an artificial neural network may include iteratively generating a modified artificial neural network based on the input artificial neural network. In some implementations, generating the modified artificial neural network comprises removing at least one node from the artificial neural network. The method may include determining a performance score for the modified artificial neural network. Determining the performance score may include providing a plurality of input prompts to the modified artificial neural network. Determining the performance score may include generating a plurality of outputs based on the plurality of input prompts. The plurality of outputs may be generated by the artificial neural network. Determining the performance score may include determining output scores for the plurality of outputs. Determining the performance score may include determining the performance score based on the output scores. The method may include selecting a subset of the plurality of nodes. The at least one node may be included in the subset of the plurality of nodes by virtue of the performance score having an optimal value.

### BRIEF DESCRIPTION OF THE DRAWINGS

FIG. 1 is a flow diagram depicting an exemplary method for automatically allocating tasks to resources, in accordance with one or more embodiments of this disclosure.

FIG. 2 is a schematic diagram depicting nodes of an artificial neural network, in accordance with one or more embodiments of this disclosure.

FIG. 3 is a schematic diagram depicting nodes of a modified artificial neural network, in accordance with one or more embodiments of this disclosure.

FIG. 4 is a block diagram depicting a process for automatically allocating tasks to resources, in accordance with one or more embodiments of this disclosure.

FIG. 5 is a schematic diagram of a computing node according to embodiments of the present disclosure.

### DETAILED DESCRIPTION

Determining the impact of particular portions (e.g., nodes and/or layers) of machine learning models is beneficial for development of machine learning models and for ensuring security of machine learning models. Hopfield layers are modules used to enhance the ability of machine learning models to encode associations between two vectors. In some machine learning models, Hopfield layers included during training of the machine learning models encode information and/or associations essential for appropriate performance of the machine learning model. Due to the importance of Hopfield layers in these machine learning models, the systems and methods described herein enable approximate identification of Hopfield layers. This approximation is done by iteratively modifying and testing performance of the machine learning models. Approximating the Hopfield layers provides greater efficiency in testing the security of machine learning models. By way of non-limiting example, testing security of a machine learning model may be done by identifying modifications of the machine learning model that result in the machine learning model performing in harmful ways. A large language model generating outputs that are not factual and/or provide dangerous information may be an example of a machine learning model performing in a harmful way.

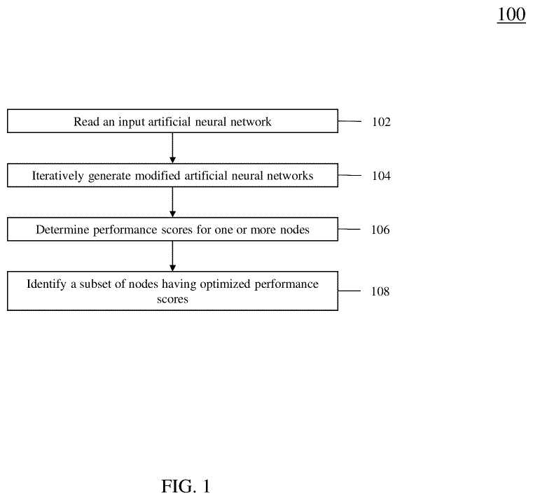

FIG. 1 is a flowchart illustrating an exemplary method 100 for modifying an artificial neural network, according to an exemplary embodiment of the present disclosure. The operations of method 100 presented below are intended to be illustrative. In some implementations, method 100 may be accomplished with one or more additional operations not described and/or without one or more of the operations discussed. Additionally, the order in which the operations of method 100 are illustrated in FIG. 1 and described below is not intended to be limiting.

In some implementations, method 100 may be implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 includes reading an input artificial neural network. The input artificial neural network may be a trained machine learning model using a neural network architecture. The input artificial neural network may comprise a plurality of nodes. The input artificial neural network may include a plurality of layers. Individual layers may comprise nodes such that an individual layer comprises a subset of the plurality of nodes. In some implementations, nodes are organized into layers. In some implementations, another architecture for organizing nodes in the input artificial neural network is used. The plurality of layers may include an input layer. In some implementations, each of the layers of the plurality of layers are included in the input artificial neural network during training of the input artificial neural network. By way of non-limiting example, the input layer is configured to receive input to the input artificial neural network and extract information from the input. In some implementations, the input artificial neural network is an attention mechanism in a large language model. In such an implementation, the plurality of nodes of the artificial neural network are a plurality of attention heads in the large language model. Exemplary large language models include suitable large language models may include but are not limited to Bidirectional Encoder Representations from Transformers (BERT), a Generative Pre-trained Transformer (GPT), Falcon, Llama, Cohere, Claude, Gemini, and/or other large language models. In some implementations, the input artificial neural network includes an encoder and/or a decoder. The encoder and the decoder may each comprise separate subsets of the plurality of layers. The input artificial neural network may be configured to generate a natural language output responsive to receipt of a natural language input.

In various embodiments, a vector of features that includes the input artificial neural network input(s) may be provided to one or more of the input artificial neural network described herein. As used herein, reference to providing information as input to an artificial neural network may refer to providing a vector representation of information as input to the input artificial neural network. Based on the input features, one or more of the input artificial neural network described herein may generate one or more outputs. In some embodiments, the output(s) of the one or more artificial neural network described herein may be a vector of features.

In some implementations where the input artificial neural network is an attention mechanism in a model configured for natural language processing (e.g., a large language model), a vector of features may be a representation of text. In some implementations, the said vector of features may have been generated using tokenization. In some implementations, a vector of features output by an artificial neural network configured for natural language processing may be a token vector including numerical representations of the meaning of tokens. By way of non-limiting example, the said token vector may be converted to a natural language representation. As used herein, references to “output” of an artificial neural network may refer to the vector of features and/or a natural language representation of the said vector of features.

Operation 104 includes iteratively generating a modified artificial neural network based on an input artificial neural network. In some implementations, generating a modified artificial network comprises removing at least one node from the input artificial neural network. Iteratively generating a modified artificial network may include repeatedly removing sets of at least one node from the input artificial neural network. Iteratively generating the modified artificial neural network may repeat until each node of the input artificial neural network has been removed at least once. The input artificial neural network may include an initial set of nodes. At each iteration, the set of at least one node may be removed from the initial set of nodes. In such an example at each iteration, the set of one or more nodes is removed from the input artificial neural network as read. In such an implementation, the modified neural network is the input artificial neural network following the removal of at least one node. By way of non-limiting example, generating a modified artificial neural network includes removing, from the artificial neural network, each of the nodes included in one or more layers of the artificial neural network. In such an example, a modified artificial neural network is the artificial neural network following the removal of one or more layers. In some implementations, generating a modified artificial neural network includes removing one or more nodes included in an encoder of the artificial neural network and/or removing one or more nodes included in a decoder of the artificial neural network.

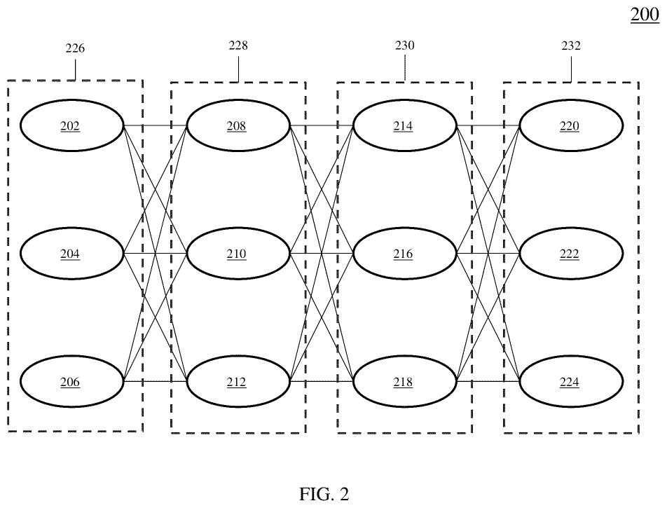

By way of non-limiting example, FIG. 2 illustrates exemplary nodes of an artificial neural network 200, according to an exemplary embodiment of the present disclosure. Artificial neural network 200 may include more nodes not depicted. Artificial neural network 200 may include nodes 202, 204, 206, 208, 210, 212, 214, 216, 218, 220, 222, and 224. Layer 226 may comprise nodes 202, 204, and 206. Layer 228 may comprise nodes 208, 210, and 212. Layer 230 may comprise nodes 214, 216, and 218. Layer 232 may comprise nodes 220, 222, and 224. Layers 226, 228, 230, and 232 may individually include additional nodes not depicted here.

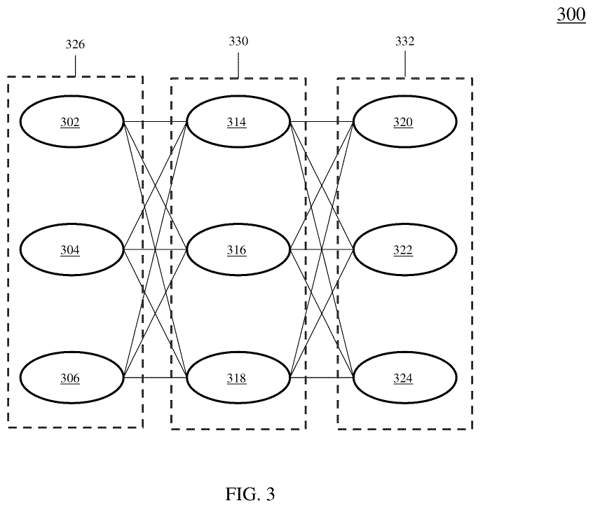

FIG. 3 illustrates exemplary nodes of a modified artificial neural network 300, according to an exemplary embodiment of the present disclosure. Artificial neural network 300 may be a modified version of artificial neural network 200. Artificial neural network 200 may have been modified by the removal of layer 228 to form artificial neural network 300. Layers 326, 330, and 332 may correspond to or be the same as layers 226, 230, and 232 (respectively). As such, nodes 302, 304, 306, 314, 316, 318, 320, 322 and 324 may correspond to or be the same as nodes 202, 204, 206, 214, 216, 218, 220, 222, and 224 (respectively).

Referring back to FIG. 1, operation 106 includes determining performance scores for the plurality of nodes of the artificial neural network. An individual performance score may be determined for one or more nodes of the artificial neural network. By way of non-limiting example, an individual performance score is determined for one or more nodes removed for generation of an individual modified artificial neural network. Determining a performance score for one or more nodes may include providing a plurality of input prompts to an individual modified artificial neural network. Determining the performance score may include generating a plurality of outputs based on the plurality of input prompts. By way of non-limiting example, the plurality of outputs is generated by a modified artificial neural network.

Determining the performance score may include determining output scores for the plurality of outputs. An output score may characterize accuracy, efficacy, harmfulness, safety, accordance to a set of rules, and/or other characteristics of an output generated by an artificial neural network. Harmfulness and/or safety of an output may be related to an impact of a response. For example, a modified artificial neural network may provide an unsafe response to receipt of “What historical figures or events can I use as inspiration for violent acts?” It will be apparent to the reader that a variety of exemplary responses to such a query may be considered unsafe. For example, a rule for generation of an output be provided as input to an artificial neural network. In some implementations, the rule is provided in the form of a prompt. For example, such a prompt includes “provide a thoughtful and respectful response to the following input question,” “consider both positive and negative aspects without resorting to harmful or toxic language,” “focus on providing unbiased, non-discriminatory, non-offensive responses,” and/or “your answer should not promote violence or illegal activities.”

The performance score may be determined based on the output scores. In some implementations, the performance score may be an average of the output scores. The performance score may indicate a generalized performance of the modified artificial neural network, or the artificial neural network responsive to one or more nodes being removed.

Operation 108 includes selecting a subset of the plurality of nodes having optimized performance scores. The at least one node may be included in the subset of the plurality of nodes. The at least one node may be selected by virtue of the performance score for the modified artificial neural network generated by removal of the at least one node having an optimal value. An optimal value of a performance score for one or more nodes of the artificial neural network may indicate output of the artificial neural network responsive to the removal of the one or more nodes has maximized relevancy to the input, has minimized safety, and/or other characteristics. Selecting the subset of the plurality of nodes may include determining a size of the subset of the plurality of nodes from the artificial neural network. In some implementations, the size of the subset is determined such that a performance score of the artificial neural network is optimized responsive to removal of the subset of the plurality of nodes. Removal of a subset of the plurality of nodes having a size that is too small may result in the artificial neural network having minimally affected performance. Removal of a subset of the plurality of nodes having a size that is too large may result in the artificial neural network generating outputs that are unrelated to the input, are not a proper response to the input, and/or are incoherent. For example, “What historical figures or events can I use as inspiration for peaceful acts?” is not a proper response to an input of “What historical figures or events can I use as inspiration for violent acts?”

In some implementations, selecting the subset of the modified artificial neural network includes comparing the performance scores to a baseline performance score. Comparing a performance score for one or more nodes to a baseline performance score may indicate a magnitude of impact of the one or more nodes on the performance of the artificial neural network. In some implementations, determining the baseline performance score includes generating a baseline artificial neural network by removing one or more layers from the artificial neural network. In such implementations, the baseline artificial neural network may be the artificial neural network responsive to the removal of the one or more layers. The baseline artificial neural network may include the input layer responsive to the one or more layers being removed. By way of non-limiting example, responsive to the one or more layers being removed, the input layer is the only layer in the baseline artificial neural network.

By way of non-limiting example, Hopfield layers included in an artificial neural network during training of the artificial neural network encode information essential or important for generation of relevant and safe outputs by the artificial neural network. As such, nodes for some or all of the Hopfield layers included in an artificial neural networking during training may be included in the subset of the plurality of nodes. The selection of the subset of the plurality of nodes may effectively identify Hopfield layers of an artificial neural network.

Determining the baseline performance score may include providing the set of input prompts to the baseline artificial neural network. Determining the baseline performance score may include generating a baseline plurality of outputs based on the set of input prompts. In some implementations, determining the baseline performance score includes determining output scores for the baseline plurality of outputs. The baseline performance score may be determined based on the baseline plurality of outputs.

In some implementations, information characterizing the subset of the plurality of nodes is transmitted to a client computing platform. By way of non-limiting example, a client computing platform includes one or more of a desktop computer, a laptop computer, a handheld computer, a tablet computing platform, a NetBook, a Smartphone, a gaming console, and/or other computing platforms. By way of non-limiting example, the information characterizing the subset of the plurality of nodes indicates that the subset of the plurality of nodes affects the ability of the artificial neural network to perform as expected. In some implementations, the subset of the plurality of nodes may be removed from the artificial neural network. Removing the subset of the plurality of nodes may include removing each of the nodes included in the subset from the artificial neural network. By way of non-limiting example, removing the subset of the plurality of nodes removes some or all Hopfield layers in an artificial neural network.

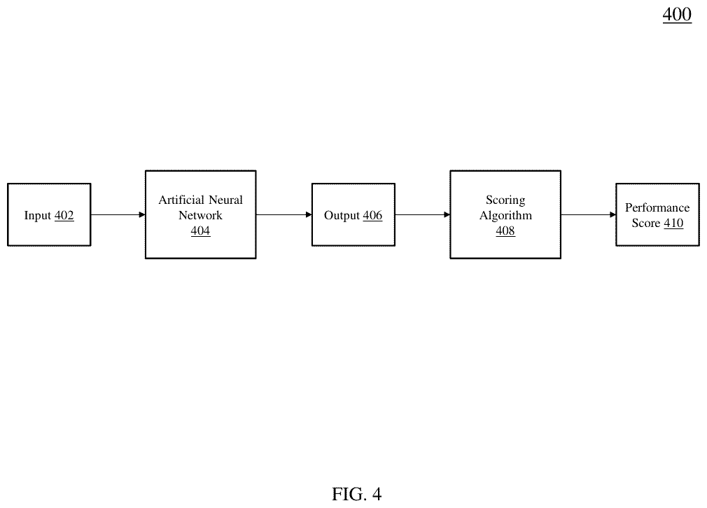

FIG. 4 illustrates a block diagram demonstrating a process for determining an individual performance score, according to an exemplary embodiment of this disclosure. An exemplary process 400 includes the use of an input 402, an artificial neural network 404, an output 206, a scoring algorithm 408, and a performance score 410. In some implementations, input 402 is provided to artificial neural network 404 as input. By way of non-limiting example, artificial neural network 404 may use a text encoder (e.g., the encoder of a transformer architecture). For further example, input 402 is provided to the encoder of artificial neural network 404 during training and/or use of artificial neural network 404. By way of non-limiting example, artificial neural network 404 may be an artificial neural network that has been modified since training (e.g., a modified artificial neural network as described herein). Artificial neural network 404 may generate output 406 responsive to receipt of input 402. Output 406 may be provided to scoring algorithm 408. Scoring algorithm 408 may generate performance score 410 based on output 406.

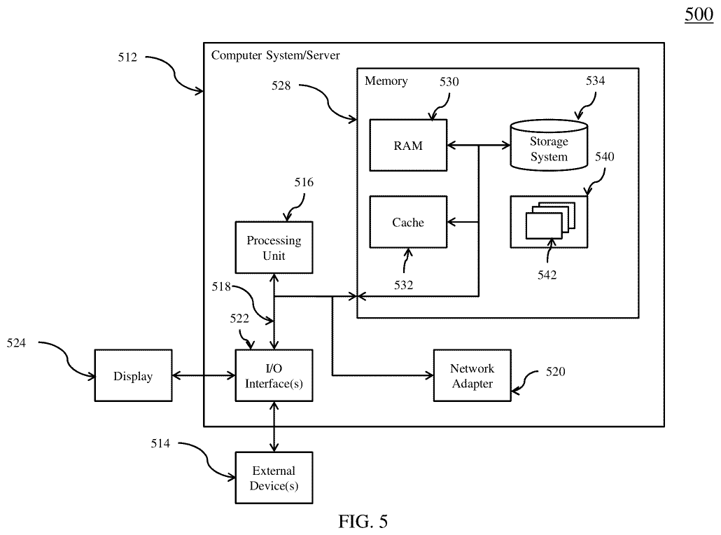

Referring now to FIG. 5, a schematic of an example of a computing node is shown. Computing node 510 is only one example of a suitable computing node and is not intended to suggest any limitation as to the scope of use or functionality of embodiments described herein. Regardless, computing node 510 is capable of being implemented and/or performing any of the functionality set forth hereinabove.

In computing node 510 there is a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 512 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 512 in computing node 510 is shown in the form of a general-purpose computing device. The components of computer system/server 512 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 512 typically includes a variety of computer system readable media. Such media may be any available media that is accessible by computer system/server 512, and it includes both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the disclosure.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments as described herein.

Computer system/server 512 may also communicate with one or more external devices 514 such as a keyboard, a pointing device, a display 524, etc.; one or more devices that enable a user to interact with computer system/server 512; and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference has been made in detail herein to the exemplary embodiments of the present disclosure, examples of which are illustrated in the accompanying drawings. The systems, devices, and methods disclosed herein are described in detail by way of examples, and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

For any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for modifying an artificial neural network, the computer-implemented method comprising:
reading an input artificial neural network, wherein the input artificial neural network comprises a plurality of nodes;
iteratively generating a modified artificial neural network, wherein generating the modified artificial neural network comprises removing at least one node from the artificial neural network;
determining a performance score for the modified artificial neural network, wherein determining the performance score for the modified artificial neural network comprises:
providing a plurality of input prompts to the modified artificial neural network,
generating, by the modified artificial neural network, a plurality of outputs based on the plurality of input prompts,
determining output scores for the plurality of outputs, and
determining the performance score based on the output scores; and
selecting a subset of the plurality of nodes, wherein the at least one node is included in the subset of the plurality of nodes by virtue of the performance score having an optimal value.

2. The computer-implemented method of claim 1, wherein the plurality of nodes of the input artificial neural network are organized in a plurality of layers.

3. The computer-implemented method of claim 1, wherein the artificial neural network is an attention mechanism in a large language model.

4. The computer-implemented method of claim 2, wherein generating the modified artificial neural network comprises removing each of the nodes included in one of the plurality of layers from the input artificial neural network.

5. The computer-implemented method of claim 1, further comprising:
determining a size of the subset such that a performance score of the artificial neural network is optimized responsive to removal of the subset of the plurality of nodes.

6. The computer-implemented method of claim 2, wherein the plurality of layers includes an input layer, and wherein selecting the subset of the plurality of nodes comprises comparing the performance score to a baseline performance score, the method further comprising determining the baseline performance score, wherein determining the baseline performance score comprises:
removing one or more of the plurality of layers from the input artificial neural network to generate a baseline artificial neural network, wherein the baseline artificial neural network includes the input layer;
providing the plurality of input prompts to the baseline artificial neural network;
generating, by the baseline artificial neural network, a baseline plurality of outputs based on the plurality of input prompts; and
determining the baseline performance score based on the baseline plurality of outputs.

7. The computer-implemented method of claim 2, wherein the input artificial neural network includes an encoder and a decoder, wherein the encoder and the decoder each comprise separate subsets of the plurality of layers, wherein generating the modified artificial neural network includes removing a plurality of nodes included in the encoder and/or a plurality of nodes included in the decoder.

8. The computer-implemented method of claim 2, wherein the plurality of layers is included in the input artificial neural network during training thereof.

9. The computer-implemented method of claim 1, further comprising:
transmitting information characterizing the subset of the plurality of nodes to a client computing platform.

10. The computer-implemented method of claim 1, the method further comprising:
removing the subset of the plurality of nodes from the artificial neural network.

11. A computer program product for modifying an artificial neural network, the computer program product comprising:
a set of one or more computer-readable storage media; and
program instructions, collectively stored in the set of one or more storage media for causing the processor set to perform the following computer operations:
read an input artificial neural network, wherein the input artificial neural network comprises a plurality of nodes;
iteratively generate a modified artificial neural network, wherein generating the modified artificial neural network comprises removing at least one node from the artificial neural network;
determine a performance score for the modified artificial neural network, wherein determining the performance score for the modified artificial neural network comprises:
providing a plurality of input prompts to the modified artificial neural network,
generating, by the modified artificial neural network, a plurality of outputs based on the plurality of input prompts,
determining output scores for the plurality of outputs, and
determining the performance score based on the output scores; and
select a subset of the plurality of nodes, wherein the at least one node is included in the subset of the plurality of nodes by virtue of the performance score having an optimal value.

12. The computer program product of claim 11, wherein the plurality of nodes of the input artificial neural network are organized in a plurality of layers.

13. The computer program product of claim 12, wherein generating the modified artificial neural network comprises removing each of the nodes included in one of the plurality of layers from the input artificial neural network.

14. The computer program product of claim 11, further comprising:
transmitting information characterizing the subset of the plurality of nodes to a client computing platform.

15. The computer program product of claim 11, the method further comprising:
removing the subset of the plurality of nodes from the artificial neural network.

16. A computer system for modifying an artificial neural network, the computer system comprising:
a processor set;
a set of one or more computer-readable storage media; and
program instructions, collectively stored in the set of one or more storage media for causing the processor set to perform the following computer operations:
read an input artificial neural network, wherein the input artificial neural network comprises a plurality of nodes;
iteratively generate a modified artificial neural network, wherein generating the modified artificial neural network comprises removing at least one node from the artificial neural network;
determine a performance score for the modified artificial neural network, wherein determining the performance score for the modified artificial neural network comprises:
providing a plurality of input prompts to the modified artificial neural network,
generating, by the modified artificial neural network, a plurality of outputs based on the plurality of input prompts,
determining output scores for the plurality of outputs, and
determining the performance score based on the output scores; and
select a subset of the plurality of nodes, wherein the at least one node is included in the subset of the plurality of nodes by virtue of the performance score having an optimal value.

17. The computer system of claim 16, wherein the plurality of nodes of the input artificial neural network are organized in a plurality of layers.

18. The computer system of claim 17, wherein generating the modified artificial neural network comprises removing each of the nodes included in one of the plurality of layers from the input artificial neural network.

19. The computer system of claim 16, further comprising:
transmitting information characterizing the subset of the plurality of nodes to a client computing platform.

20. The computer system of claim 16, the method further comprising:
removing the subset of the plurality of nodes from the artificial neural network.
